(19) United States
(12) Patent Application Publication
(10) Pub. No.: US 2025/0321181 A1
(43) Pub. Date: Oct. 16, 2025

(54) DETECTION OF DEPOSITS AND/OR CONTAMINATION ON A SENSOR SURFACE WITHIN A VESSEL OR A LINE WITH A FLOWING MEDIUM

(71) Applicant: Frank Seida, Werne (DE)

(72) Inventor: Frank Seida, Werne (DE)

(21) Appl. No.: 18/865,526

(22) PCT Filed: May 20, 2022
(86) PCT No.: PCT/DE2022/100388

§ 371 Date: Nov. 13, 2024

(51) Int. Cl. G01N 17/00; G01N 25/18

(52) U.S. Cl. CPC G01N 17/008; G01N 25/18

(57) ABSTRACT

A detection device for detecting deposits and/or soiling on a sensor surface inside a vessel or a line containing a flowing medium, the detection device includes: a detection section; a thermally conductive main body; a heat or cold source arranged on the thermally conductive main body for producing a primary flow of heat between the heat or cold source and the sensor surface and a secondary flow of heat between the heat or cold source and a reference surface; a first temperature sensor on the thermally conductive main body at a first distance from the sensor surface, and a second temperature sensor on the thermally conductive main body at a second distance from the sensor surface; a thermally conductive enveloping body; the reference surface is part of the detection section, and the detection device includes exterior insulation that insulates the thermally conductive enveloping body.

### CROSS REFERENCE TO RELATED APPLICATIONS

This application is a US National Stage Entry of PCT/DE2022/100388 filed on May 20, 2022, the entirety of which is hereby incorporated by reference herein for all purposes.

### FIELD

The present invention relates to a detection device for detecting deposits and/or soiling on a sensor surface inside a vessel or a line containing a flowing medium. A further subject of the invention is a detection arrangement for detecting deposits and/or soiling from a flowing medium on a wall of a vessel or a line having such a detection device. Further, the invention relates to a method for detecting deposits and/or soiling on a sensor surface inside a vessel or a line containing a flowing medium using a first detection device.

### BACKGROUND

DE 10 2009 009 592 A1 discloses the practice of arranging two temperature sensors in an embossment on an outside of a pressure pipe of a heat exchanger in order to determine the flow of heat between the two temperature sensors. Additionally, there is provision for a third temperature sensor, a further flow of heat being determined by means of the temperatures measured by the three temperature sensors. The response of these two flows of heat over time is monitored and used to identify a soiling state of the outside of the pressure pipe. This method has been found to have the disadvantage that the soiling state can be identified only when there is a temperature difference between the inside and the outside of the pressure pipe. This temperature difference is produced by the process. This greatly restricts reliable detection of deposits at all operating points of the pressure pipe and reduces measurement accuracy to an extreme degree.

WO 2014/099 755 A1 describes a method for detecting deposits and/or soiling caused by a liquid flowing medium on a surface of a heated sensor. The sensor is arranged in a flow cell carrying the medium and encompasses a thermally conductive block containing a heating apparatus that produces a primary flow of heat through the block to the sensor surface. A secondary flow of heat drains away to the surroundings via a side of the block that is opposite the sensor surface. Deposits and/or soiling on the sensor surface increase the thermal resistance in the path of the primary flow of heat, whereas the secondary flow of heat is not affected by these deposits. The block encompasses two temperature sensors, which are arranged at different distances from the sensor surface and can be used to measure a temperature difference. Provided that the temperature at the end of the secondary heat path, that is to say the ambient temperature, is constant, the temperature difference of the temperature sensors is linearly dependent on the thickness of the deposits on the sensor surface. The method can therefore be used to identify deposits and/or soiling on the sensor surface by measuring the temperature difference in the thermally conductive block that carries the primary flow of heat. However, the known method has been found to have the disadvantage that inaccuracies in the ascertainment of the thickness of the deposits and/or soiling can arise if a property of the medium to which the sensor surface is exposed changes, for example the temperature, flow rate, viscosity or concentration of a constituent of the medium. To avoid these inaccuracies, WO 2014/099 755 A1 proposes having the same medium flow around the other sides of the thermally conductive block as the sensor surface, with the result that the surroundings of the block are at the same temperature as the medium. Changes in the temperature of the liquid medium then affect both the primary and the secondary flow of heat and compensate for one another. However, a sensor flowed around in such a manner requires additional lines for the medium and takes up a relatively large amount of installation space.

### SUMMARY

The object of the present invention is to permit reliable detection of deposits and/or soiling in the event of changes in properties of the flowing medium that causes the deposits and/or soiling, for example the temperature, flow rate, viscosity and/or concentration of a constituent, using a compact detection device.

The object is achieved by proposing a detection device for detecting deposits and/or soiling on a sensor surface inside a vessel or a line containing a flowing medium, wherein the detection device encompasses:
a detection section that comprises the sensor surface and is configured to be arranged inside the vessel or inside the line in contact with the flowing medium,
a thermally conductive main body that comprises or is in direct contact with the sensor surface,
a heat or cold source, arranged on the main body, for producing a primary flow of heat between the heat or cold source and the sensor surface and a secondary flow of heat between the heat or cold source and a reference surface,
a first temperature sensor, which is arranged on the main body at a first distance from the sensor surface, and a second temperature sensor, which is arranged on the main body at a second distance from the sensor surface, the second distance being greater than the first distance, the temperature sensors being able to be used to ascertain a temperature difference,
a thermally conductive enveloping body that envelops a part of the main body arranged outside the detection section and comprises the reference surface,
   wherein the reference surface is part of the detection section, and the detection device encompasses an exterior insulation that insulates the enveloping body with respect to its exterior surroundings.

The thermally conductive main body either comprises or is in direct contact with the sensor surface on which the deposits and/or soiling can be detected. The first and second temperature sensors are each arranged at different distances from the sensor surface. The heat or cold source arranged on the main body allows a temperature gradient that is proportional to the primary flow of heat to be set in the main body. When the sensor surface is unchanged, this temperature difference is constant. Just slight deposits and/or soiling on the sensor surface lead to a rise in the thermal resistance, i.e. to a decrease in the primary flow of heat, which can be measured as a change in the temperature difference between the first temperature sensor and the second temperature sensor. The heat or cold source arranged on the main body means that it is fundamentally possible to set a temperature difference between the first and second temperature sensors even for a small temperature difference between the sensor surface and the surroundings of the main body. It is therefore possible to reliably detect soiling or deposits on the sensor surface. The detection device according to the invention also encompasses a thermally conductive enveloping body that envelops the main body in the region outside the detection region, that is to say outside the vessel or the line. The enveloping body carries the secondary flow of heat and comprises the reference surface, which—like the sensor surface—is arranged inside the vessel or the line in order to be in contact with the flowing medium to be monitored. The formation of deposits or soiling on the sensor surface leads to a measurable change in the ratio of the primary flow of heat to the secondary flow of heat. The detection device according to the invention therefore permits reliable identification of the soiling or deposits. In accordance with the invention, there is provision for the detection section, which is configured to be arranged inside the vessel or inside the line in contact with the flowing medium, to comprise both the sensor surface and the reference surface. The enveloping body is also insulated with respect to the surroundings by the exterior insulation. Therefore, both the primary flow of heat (to the sensor surface) and the secondary flow of heat (to the reference surface) are routed into the flowing medium inside the vessel or the line. Changes in the liquid, for example changes in the temperature, flow rate, viscosity and/or concentration of a constituent, therefore affect the primary and secondary flows of heat and do not lead to inaccuracies in the detection of deposits and/or soiling. The enveloping body is insulated with respect to the surroundings by the exterior insulation, and so it is necessary neither to have the liquid flow around the enveloping body nor to actively cool or actively heat said enveloping body. In the detection device according to the invention, additional lines for the liquid or measures for controlling the temperature of the enveloping body can be dispensed with. A space-saving, compact design is facilitated.

Since the reference surface in the detection device according to the invention—unlike in the prior art according to WO 2014/099 755 A1, for instance—is in contact with the liquid, deposits and/or soiling can also form on the reference surface. Since the secondary flow of heat through the reference surface is less than the primary flow of heat through the sensor surface, a lower temperature can be reached on the reference surface than on the sensor surface, and so the formation of deposits and/or soiling on the reference surface can be mini-mized.

The flowing medium in the vessel or the line may be a liquid medium or a gaseous medium or a partially liquid and partially gaseous medium.

Preferably, the exterior insulation insulates the enveloping body with respect to its exterior surroundings in such a way that the secondary flow of heat is greater than a parasitic flow of heat between the heat or cold source and the surroundings through the enveloping body and through the exterior insulation.

By way of example, the enveloping body may be produced from a metal. Preferably, the enveloping body is produced from titanium. Alternatively, there can be provision for the enveloping body to be produced from a plastic.

Preferably, the detection section is a detection surface. In this respect, the sensor surface and the reference surface may be arranged in alignment with one another.

If the detection device comprises a heat source, said heat source is preferably in the form of an adjustable, particularly preferably regulable, in particular regulated, heat source. If the detection device comprises a cold source, said cold source is preferably in the form of an adjustable, particularly preferably regulable, in particular regulated, cold source. The adjustable heat or cold source allows a heating power or a cooling power to be predetermined. Such a configuration affords the advantage that the temperature at the sensor surface can be influ-enced by adjusting the heat source or cold source. It is therefore possible to match the temperature of the sensor surface to the temperature of the flowing medium present on the sensor surface. Further, the detection device can be used to emulate a transfer of heat via a wall of the process vessel or a process line. By way of example, a computed temperature at a reference location inside the main body can be adjusted in such a way that said temperature corresponds to a temperature at an interior or exterior wall of the process vessel or the process line. The distance of the reference location from the sensor surface can be chosen in such a way that said distance—taking account of the thermal conductivity of the material—corresponds to a wall thickness of the wall of the process vessel or the process line.

A configuration in which the heat or cold source and the first temperature sensor and the second temperature sensor are arranged along a virtual straight line has been found to be advantageous in terms of design.

The heat source may be a heating element, for example an electrical, in particular resistive, heating element. By way of example, the cold source may be a Peltier element.

Preferably, there is provision in the main body for a first recess containing the first temperature sensor and/or for a second recess containing the second temperature sensor and/or for a third recess containing the heat source or the cold source. The provision of recesses permits the respective temperature sensor or the heat or cold source to be sustainably attached to the main body with little manufacturing effort. The third recess, containing the heat source or the cold source, is preferably arranged on a rear surface of the main body, which surface is opposite the sensor surface. The first and second recesses, containing the temperature sensors, are preferably arranged between the sensor surface and the rear surface. The first, second and/or third recess may in each case be in the form of a bevel in an, in particular cylindrical, exterior wall of the main body. Alternatively, it is possible for the first, second and/or third recess to be in the form of a blind hole.

In accordance with one advantageous configuration, there is provision for the main body to be bar-shaped, in particular with a round cross section. Alternatively, there can be provision for the main body to have a triangular, quadrangular, pentangular, hexagonal, heptagonal, octagonal or polygonal cross section.

One advantageous configuration of the invention provides for the main body to be isotropic and homogeneous in respect of its thermal conductivity. This means that the thermal conductivity of the main body is identical over its entire extent and is not dependent on the direction in which thermal conduction takes place. In such a configuration, a linear temperature response can be facilitated in the main body from the heat or cold source to the sensor surface. The main body is manufactured in particular from one of the following materials: steel, copper, brass, in particular CuZn39Pb3 (obsolete term Ms 58).

In accordance with one advantageous configuration, there is provision for the detection device to encompass a third temperature sensor arranged on the main body at a third distance from the sensor surface, the third distance being greater than the second distance. The heat or cold source and the first temperature sensor and the second temperature sensor and the third temperature sensor are preferably arranged along a virtual straight line. It is advantageous in terms of design if the main body encompasses a further recess, for example a further blind hole, that contains the third temperature sensor. The third temperature sensor allows additional information to be obtained that improves the detection of deposits and/or soiling further. By way of example, the third temperature sensor can be used instead of the first or instead of the second temperature sensor if the first or second temperature sensor is faulty or a temperature cannot be measured for another reason. Further, it is possible to ascertain both a temperature difference between the first temperature sensor and the second temperature sensor and a temperature difference between the second temperature sensor and the third temperature sensor. These temperature differences and the respective distance of the temperature sensors from one another can be used to determine a temperature gradient between the first and second temperature sensors and a temperature gradient between the second and third temperature sensors. These temperature gradients ideally need to be identical. Should the temperature gradients differ from one another, this can indicate a heat loss in a direction perpendicular to the straight line between the heat or cold source and the sensor surface. By way of example, this can indicate poor thermal insulation or undesirable entry of a medium into the detection device.

Preferably, there is provision for the heat source to be arranged at a fourth distance from the sensor surface, the fourth distance being greater than the second distance, possibly greater than the third distance.

A configuration of the invention in which the detection device encompasses an insulation means that surrounds the main body and that is arranged between an exterior contour of the main body and an interior contour of the enveloping body has been found to be advantageous. In such a configuration, the insulation means is situated in the path of the second flow of heat. Preferably, the thermal resistance of the second heat path is higher than the thermal resistance of the first heat path without deposits and/or soiling on the sensor surface.

A configuration in which the insulation means surrounding the main body has an identical thermal resistance on all sides of the main body is advantageous. In particular, the insulation means has an identical thermal resistance on an end face of the main body that is opposite the sensor surface and on a radial peripheral face of the main body.

One advantageous configuration provides for the insulation means surrounding the main body to comprise a fill or a porous material, for example a foam. The fill preferably comprises particles having a particle size (equivalent-volume sphere diameter) in the range from 1 micrometer to 10 millimeters, preferably in the range from 1 micrometer to 1 millimeter, particularly preferably in the range from 1 micrometer to 100 micrometers, for example in the range from 1 micrometer to 10 micrometers. The grain size distribution of the fill is preferably as homogeneous as possible. The fill preferably encompasses organic particles, for example foamed polystyrene, and/or inorganic particles, for example minerals, salts of mineral acids, pozzolans or clay minerals. Preferably, the fill is arranged between the main body and the enveloping body in such a way that it is not mobile.

An alternative, advantageous configuration provides for the insulation means surrounding the main body to encompass a gas or gas mixture or to be a gas or gas mixture enclosed between the main body and the enveloping body. The gas mixture can be air, for example.

Preferably, the exterior insulation comprises an insulator body. One advantageous configuration provides for the exterior insulation that insulates the enveloping body with respect to the surroundings to comprise glass wool and/or wood wool and/or stone wool.

The object mentioned at the outset is further achieved by proposing a detection arrangement for detecting deposits and/or soiling from a flowing medium on a wall of a vessel or a line having a detection device as described hereinabove, wherein the detection section comprising the sensor surface and the reference surface is provided as part of the wall.

The use of such a detection device reliably allows deposits and/or soiling from a flowing medium that accumulate on a wall of a vessel or a line to be detected. The detection device is provided as part of the wall of the vessel or the line, and so the same deposit formations ap-pear on the sensor surface of the detection device as on the rest of the wall.

The wall is preferably an interior wall, that is to say an interior surface of a wall. Alternatively, the wall can be an exterior wall, that is to say an exterior surface of a wall, for example an exterior wall of a flame pipe. By way of example, the vessel or the line can be a part of a heat transfer system, in particular a heat exchanger, a reactor or a cooling jacket, or a pipeline connected upstream or downstream of such a heat transfer system. The vessel or the line can be part of a chemical, in particular petrochemical, plant, for example part of an evapora-tor plant, a cooling tower or a shell-and-tube heat exchanger.

One advantageous configuration of the detection arrangement provides for multiple detection devices as described hereinabove, wherein the detection section of the respective detection device, comprising the sensor surface and the reference surface, is provided as part of the wall. Such a configuration containing multiple detection devices firstly permits a redundant configuration of the detection arrangement. Furthermore, the provision of multiple detection devices allows said detection devices to be utilized for detecting different deposits. As such, different adjustment of the heating power of the respective heat sources or of the cooling power of the respective cold sources of the detection devices allows different temperatures to be set at the respective sensor surface. As a result, the detection devices can have a different sensitivity to deposits. By way of example, it becomes possible to distinguish organic deposits from inorganic deposits.

As an alternative or in addition to the advantageous configurations of the detection device that are described hereinabove, the advantageous configurations and features described in connection with the detection device can also be used on their own or in combination.

The object mentioned at the outset is further achieved with the aid of a method for detecting deposits and/or soiling on a sensor surface inside a vessel or a line containing a flowing medium using a first detection device that encompasses:
a thermally conductive main body that comprises or is in direct contact with the sensor surface,
a heat or cold source, arranged on the main body, that produces a primary flow of heat between the heat or cold source and the sensor surface and a secondary flow of heat between the heat or cold source and a reference surface,
a detection section that comprises the sensor surface and the reference surface and is arranged inside the vessel or inside the line in contact with the flowing medium,
a thermally conductive enveloping body that envelops a part of the main body arranged outside the detection section and comprises the reference surface,
an exterior insulation that insulates the enveloping body with respect to its exterior surroundings, and
a first temperature sensor, which is arranged on the main body at a first distance from the sensor surface, and a second temperature sensor, which is arranged on the main body at a second distance from the sensor surface, the second distance being greater than the first distance,
   wherein the temperature sensors of the first detection device are used to ascertain a temperature difference, and the temperature difference is taken as a basis for detecting deposits and/or soiling on a sensor surface.

The same effects and advantages can be achieved for the method as have already been ex-plained in connection with the detection device in accordance with the invention.

The method involves determining a temperature difference between the first temperature and the second temperature. Particularly preferably, a response of the temperature difference over time is monitored. A change in the temperature difference can indicate deposits and/or soiling on the sensor surface. The detection device can therefore be initialized by performing a calibration measurement in which a calibration temperature difference is determined. Temperature differences obtained by way of further measurements using the detection device can then be compared with the calibration temperature difference.

Preferably, a measure PFL of the amount or thickness of the deposits and/or soiling is ascer-tained as

$$PFL = ( 1 - \frac{Δ {T}_{12 \_ act}}{Δ {T}_{12 \_ cal}} ) * 100 \%$$

where ΔT_{12_act} is the currently measured temperature difference and ΔT_{12_cal} is the calibration temperature difference measured during a calibration.

One advantageous configuration of the method provides for the heat source to be operated with a constant heating power or for the cold source to be operated with a constant cooling power. Predetermining a constant heating or cooling power allows a temperature gradient that is stable over time—without taking deposits on the sensor surface into account—to be set in the main body, in particular between the first and second temperature sensors. In this respect, measured changes in the temperature difference between the first temperature and the second temperature can indicate deposits on the sensor surface.

An alternative, advantageous configuration provides for a heating power of the heat source or a cooling power of the cold source to be adjusted according to a temperature of the flowing medium that causes the deposits and/or soiling. This allows a configuration to be ob-tained in which the temperature of the heating apparatus follows the temperature of the medium flowing in the vessel or the line. Such a configuration is advantageous in particular in the case of batch processes in which the temperature of the flowing medium changes over the course of the batch process.

The method according to the invention for detecting deposits and/or soiling on a sensor surface inside a vessel or a line containing a flowing medium can further be used to identify deposits on a wall of a heat exchanger permitting an exchange of heat between a process medium and the cooling medium that are caused by an, in particular liquid, cooling medium. This does not require the detection device to be arranged inside the heat exchanger. Rather, in accordance with one advantageous configuration of the method according to the invention, there is provision for the first detection device to be arranged in a supply or discharge line, filled with the cooling medium, of a heat exchanger, the heat exchanger permitting an exchange of heat through a heat exchanger wall between a process medium and the cooling medium, wherein a heating power of the heat source or a cooling power of the cold source is adjusted according to a process temperature of the process medium.

Preference is given to a configuration in which the process temperature and a thermal conductivity of the heat exchanger wall and a wall thickness of the heat exchanger wall are taken as a basis for ascertaining a virtual distance at which the process temperature needs to be from the sensor surface in the main body of the first detection device in order to set substantially the same temperature at the sensor surface as at the surface of the heat exchanger wall that is in contact with the cooling medium. The virtual distance xₑₘᵤₗ can be calculated using the following formula, for example:

$${x}_{emul} = {d}_{w} \cdot {λ}_{s} / {λ}_{w}$$

where
   d_{w}: wall thickness of the heat exchanger wall
   λₛ: thermal conductivity of the main body of the detection device
   λ_{w}: thermal conductivity of the heat exchanger wall.

The process temperature can be predetermined by a user, that is to say as a constant value or as a temperature response. Alternatively, it is possible to measure the process temperature by means of a process temperature sensor and to factor in the measured process temperature when ascertaining the virtual distance xₑₘᵤₗ.

Preference is given to a configuration in which the heating power of the heat source or the cooling power of the cold source is additionally adjusted according to the temperatures determined using the first and second temperature sensors in such a way that the process temperature is reached at the virtual distance from the sensor surface. The heating power P of the heat source is obtained as

$$P = {λ}_{s} {A}_{s} ( {T}_{1} - {T}_{2} ) / ( {x}_{2} - {x}_{1} )$$

where
   λₛ: thermal conductivity of the main body of the detection device
   Aₛ: cross-sectional area of the main body of the detection device
   T₁: first temperature
   T₂: second temperature
   x₁: first distance (location of the first temperature sensor)
   x₂: second distance (location of the second temperature sensor)

The following setpoint values are predetermined for the first temperature T₁ and the second temperature T₂ according to the virtual distance xₑₘᵤₗ, the distances x₁, x₂ of the temperature sensors from the sensor surface and the predetermined process temperature T_{P}:

$$\begin{matrix}{T}_{1} = {T}_{P} / {x}_{emul} \cdot {x}_{1} \\ {T}_{2} = {T}_{P} / {x}_{emul} \cdot {x}_{2}\end{matrix}$$

In accordance with one advantageous configuration of the method, there is provision for a third temperature sensor to be used to measure a third temperature, said third temperature sensor being arranged on the main body at a third distance from the sensor surface, the third distance being greater than the second distance, wherein a first temperature gradient between the first and second temperature sensors and a second temperature gradient between the second and third temperature sensors are determined, preferably compared with one another. The first temperature gradient can be determined on the basis of a temperature difference between the first and second temperatures and the distance of the first and second temperature sensors from one another. Similarly, the second temperature gradient can be determined on the basis of a temperature difference between the second and third temperatures and the distance between the second and third temperature sensors. These temperature gradients ideally need to be identical. Should the temperature gradients differ from one another, this can indicate a heat loss in a direction perpendicular to the straight line between the heat or cold source and the sensor surface. By way of example, this can indicate poor thermal insulation or undesirable entry of a medium into the detection device. Particularly preferably, a third temperature gradient between the first and third temperature sensors is determined. The third temperature gradient can be determined on the basis of a temperature difference between the first and third temperatures and the distance of the first and third temperature sensors from one another. The third temperature gradient can be compared with the first and/or second temperature gradient. This is because these temperature gradients also ideally need to be identical.

In accordance with one advantageous configuration of the method, there is provision for a temperature difference between the first and second temperatures to be determined and for the determined temperature difference to be taken as a basis for introducing an additive into the process vessel or into the process line. In such a configuration, deposits can be detected when they arise, in particular in real time, and suitable countermeasures can be initiated immediately. As such, the additive can be introduced into the process vessel or the process line, in order to remove the detected deposits and/or soiling, in response to a change in the determined temperature difference, for example. In this case, it is advantageous if the addi-tive is introduced at a time shortly after the deposit is detected, since at this time any crystal-lization or polymerization reactions are not yet fully complete. The additive can be a hard-ness stabilizer or a dispersing agent. Preferably, an amount of additive introduced is set ac-cording to the determined temperature difference or the determined change in the temperature difference, and so the additive is dosed according to the soiling situation. This allows overuse of the additive to be prevented.

One advantageous configuration of the invention provides for there to be provision for a second detection device, which encompasses a, in particular bar-shaped, second main body that comprises a second sensor surface provided as part of the wall, wherein a further first temperature sensor, which is arranged on the second main body at a further first distance from the second sensor surface, is used to measure a further first temperature, wherein a further second temperature sensor, which is arranged on the second main body at a further second distance from the second sensor surface, the further second distance being greater than the further first distance, is used to measure a further second temperature, and wherein a second heat source or second cold source arranged on the second main body is used to produce a temperature gradient between the further first temperature sensor and the further second temperature sensor, the first heat source or the first cold source being operated in such a way that a first surface temperature, in particular in the range between 35° C. and 40° C., is set at the first sensor surface and the second heat source or the second cold source being operated in such a way that a second surface temperature, in particular in the range between 45° C. and 55° C., which is different than the first surface temperature, is set at the second sensor surface. The use of a first and a second detection device enables the method to distinguish different deposits and/or soiling from one another and if necessary to combat them using different measures. If for example the first surface temperature is set in the range between 35° C. and 40° C., in particular to 37° C., then organic deposits and/or soiling increasingly accumulate on the first sensor surface. If the second surface temperature is set in the range between 45° C. and 55° C., in particular to 50° C., then inorganic deposits and/or soiling increasingly accumulate on the second sensor surface. A comparison of the temperature differences recorded by the two detection devices can indicate the composition of the deposits and/or soiling formed in the vessel or in the line. Preferably, the first surface temperature and the second surface temperature are set in such a way that a surface temperature difference between the first surface temperature and the second surface temperature is in a range from 1° C. to 100° C. or in a range from 1° C. to 75° C. or a range from 1° C. to 50° C. or a range from 1° C. to 40° C. or a range from 1° C. to 30° C. or a range from 1° C. to 20° C. or a range from 1° C. to 10° C. or a range from 1° C. to 5° C. or a range from 1° C. to 3° C. By way of example, the surface temperature difference can be set to 1° C. or 2° C. or 3° C. or 4° C. or 5° C. or 6° C. or 7° C. or 8° C. or 9° C. or 10° C. or 15° C. or 20° C.

Preferably, a first temperature difference is determined using the first detection device and a first additive is introduced into the process vessel or to the process line according to the determined first temperature difference and a second temperature difference is determined using the second detection device and a second additive is introduced into the process vessel or to the process line according to the determined second temperature difference. This approach affords the advantage that additives can be added in a manner coordinated with the detected composition of the deposits. Overdosage can be effectively avoided in this way. Alternatively or additionally, the determined first or second temperature difference can be taken as a basis for triggering an alarm, or the determined first or second temperature difference can be taken as a basis for adjusting a process parameter.

In this regard, it is advantageous if a response of a temperature of the flowing medium is predetermined, the response encompassing a current first process temperature and a future, second process temperature, the first surface temperature being the first process temperature and the second surface temperature being the second process temperature. In such a configuration, the second detection device can be used to emulate the process sequence, and so deposits and/or contaminations likely to occur in future (that is to say at the second process temperature) can be detected even before they actually occur in the process sequence.

As an alternative or in addition to the advantageous configurations of the method that are described hereinabove, the advantageous configurations and features described in connection with the detection device and/or detection arrangement can also be used for the method on their own or in combination.

Further details, features and advantages of the invention will become apparent from the drawings and from the description of preferred embodiments below on the basis of the draw-ings. The drawings merely illustrate examplary embodiments of the invention that do not limit the inventive concept.

### BRIEF DESCRIPTION OF THE FIGURES

FIG. 1 shows a first exemplary embodiment of a detection device in accordance with the invention in a schematic sectional representation.

FIG. 2 shows the detection device according to FIG. 1 with the essential flows of heat highlighted.

FIG. 3 shows a first exemplary embodiment of a detection arrangement having a detection device in accordance with the invention.

FIG. 4 shows a second exemplary embodiment of a detection arrangement having multiple detection devices in accordance with the invention.

FIG. 5 shows a representation to illustrate the processes for emulating the transfer of heat in a heat exchanger.

### DETAILED DESCRIPTION

In the various figures, identical parts are always provided with the same reference signs and are therefore generally also referred to or mentioned only once in each case.

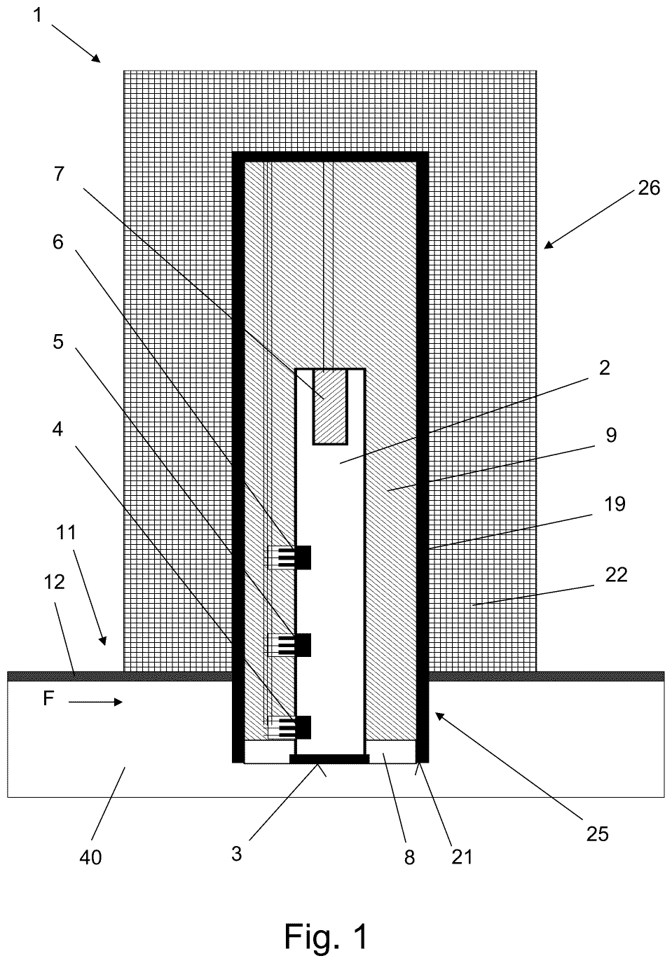

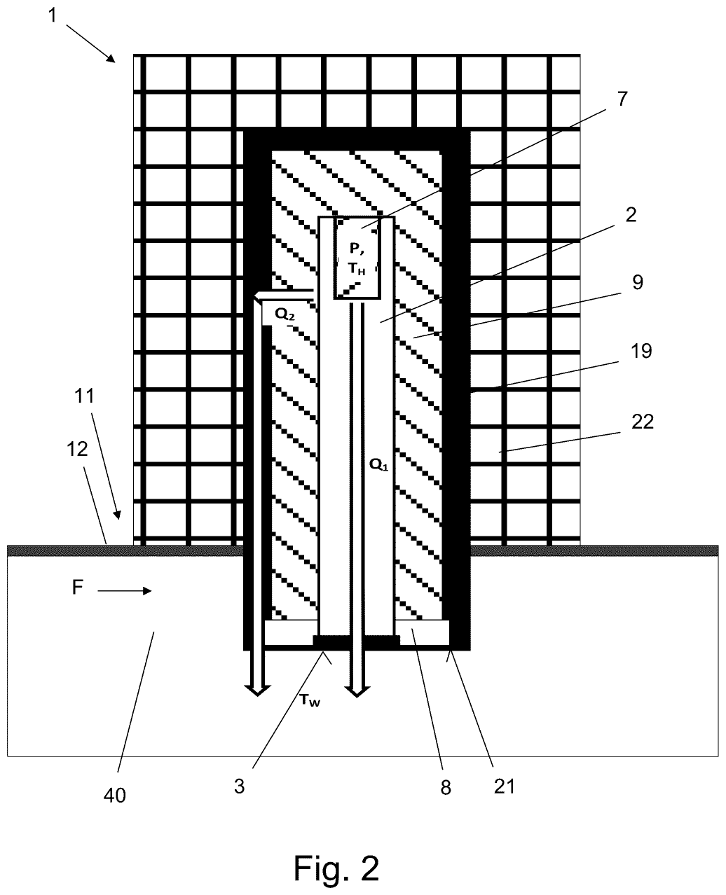

The depictions in FIG. 1 and FIG. 2 show a detection device 1 for detecting deposits and/or soiling on a sensor surface 3 inside a vessel or a line 11 that is filled with a medium 40 flowing in a direction of flow F. The detection device 1 encompasses a detection section 25, which is arranged inside the vessel or inside the line 11 in contact with the medium 40 and can therefore also be referred to as an interior section. The detection section 25 encompasses both the sensor surface 3 and a reference surface 21. Further, the detection device 1 comprises an exterior section 26 arranged outside the vessel or the line 11.

The main body 2 is in bar-shaped form and has a round cross section. In respect of its thermal conductivity, the main body 2 is isotropic and homogeneous. To this extent, it is a substantially cylindrical main body 2. The main body 2 has multiple, here precisely three, temperature sensors 4, 5, 6 arranged on it. A first temperature sensor 4 is arranged on the main body 2 at a first distance from the sensor surface 3, and a second temperature sensor 5 is arranged on the main body 2 at a second distance from the sensor surface 3, which is greater than the first distance. A third temperature sensor 6 is located on the main body 2 at a third distance, which is greater than the second distance. All of the temperature sensors are arranged on a common virtual straight line that is perpendicular to the sensor surface 3.

The sensor surface 3, in accordance with this exemplary embodiment, is in the form of a sep-arate end plate, for example made from a metal, preferably made from titanium. The main body 2 is connected directly to the end plate. Alternatively, it is possible for the sensor surface 3 to be part of the main body 2. Between the sensor surface 3 and the reference surface 21 there is provision for an insulation means 8 that thermally insulates the two surfaces. The insulation means 8 may be produced from PEEK, for example.

A further component of the detection device 1 is a heat source 7, arranged on the main body, that can be used to produce a temperature difference between the first temperature sensor 4 and the second temperature sensor 5 and between the second temperature sensor 5 and the third temperature sensor 6 and between the first temperature sensor 4 and the third temperature sensor 6. Instead of the heat source 7, there can alternatively be provision for a cold source. The heat source 7, in accordance with the exemplary embodiment, is an electrical heating element that can resistively heat the main body. The heat source 7 is arranged at a fourth distance from the sensor surface 3, which is greater than the first, second and third distances. In the present exemplary embodiment, the heat source 7 is arranged on a rear surface of the main body 2 that is arranged opposite the sensor surface of the main body 2. A first heat path, which conducts the primary flow of heat, is thus provided in the main body 2 from the heat source 7 to the sensor surface 3, cf. FIG. 2.

The detection device 1 further encompasses an enveloping body 19 that envelops the main body 2 on its peripheral side and on the end face that is opposite the sensor surface 3. In this respect, the region of the main body 2 that is arranged in the exterior region 26 is enveloped by the enveloping body 19 and only the detection section 25 is uncovered. By way of example, the enveloping body 19 may be made from a metal, in particular titanium. The enveloping body 19 provides a second heat path that carries the secondary flow of heat Q2, which runs from the heat source 7 through the enveloping body 19 to the reference surface 21 of the enveloping body 19, cf. FIG. 2.

The main body 2 and the enveloping body 19 have an insulation means 9 arranged between them. Said insulation means is in the form of a fill or in the form of a porous material. Alternatively, the insulation means 9 can encompass a gas or gas mixture, for example air. The exterior contour of the enveloping body 19 is insulated from the surroundings by an exterior insulation 22. The exterior insulation comprises an insulator body, which is produced from glass wool, for example.

The following relationships apply for the detection device 1 shown in FIG. 2, the heating apparatus 7 having a power P and a temperature T_{H} and the flowing medium 40 having a temperature T_{W}:

$$P = {\dot{Q}}_{1} + {\dot{Q}}_{2} \qquad ( 1 )$$

$$Δ {T}_{HW} = {T}_{H} - {T}_{W} \qquad ( 2 )$$

$${R}_{th 1} = \frac{Δ T}{{\dot{Q}}_{1}} \qquad ( 3 )$$

$${R}_{th 2} = \frac{Δ T}{{\dot{Q}}_{2}} \qquad ( 4 )$$

$${\dot{Q}}_{1} = \frac{{PR}_{th 2}}{{R}_{th 1} + {R}_{th 2}} \qquad ( 5 )$$

$${\dot{Q}}_{2} = \frac{{PR}_{th 2}}{{R}_{th 1} + {R}_{th 2}} \qquad ( 6 )$$

$${R}_{th 1} = {R}_{1 A} + {R}_{1 B} + {R}_{1 C} + {R}_{1 F} \qquad ( 7 )$$

$${R}_{th 2} = {R}_{2 A} + {R}_{2 B} + {R}_{2 C} + {R}_{2 F} \qquad ( 8 )$$

P . . . heating power of the heating apparatus 7
Q₁ . . . flow of heat, path 1
Q₂ . . . flow of heat, path 2
T_{H} . . . temperature of the heating apparatus 7
T_{W} . . . temperature of the flowing medium 40
ΔT_{HW} . . . temperature difference from the heating apparatus 7 to the flowing medium 40
Rₜₕ₁ . . . absolute thermal resistance, path 1
Rₜₕ₂ . . . absolute thermal resistance, path 2
R_{1A} . . . thermal resistance, path 1, measuring rod
R_{1B} . . . thermal resistance, path 1, contact plate
R_{1C} . . . thermal resistance, path 1, transfer to the flowing medium 40
R_{1F} . . . thermal resistance, path 1, deposit (fouling)
R_{2A} . . . thermal resistance, path 2, interior insulation
R_{2B} . . . thermal resistance, path 2, housing sleeve
R_{2C} . . . thermal resistance, path 2, transfer to the flowing medium 40
R_{2F} . . . thermal resistance, path 2, deposit (fouling)

For the measurement section with the flow of heat Q₁ and the measurement points P₁ (first temperature sensor 4 at the temperature T₁) and P₂ (second temperature sensor 5 at the temperature T₂) it holds true that:

$${T}_{2} - {T}_{1} = Δ {T}_{12} = {R}_{1 A \_ 12} * {\dot{Q}}_{1} \qquad ( 9 )$$

T₁ . . . temperature of the main body 2 at point P₁
T₂ . . . temperature of the main body 2 at point P₂
ΔT₁₂ . . . temperature difference between points P₁ and P₂
R_{1A_12} . . . thermal resistance in the primary heat path 1 between points P₁ and P₂

A measure of the amount or thickness of the deposits and/or soiling is the performance loss PFL in %. This is defined for measurements without deposits (calibration=cal) and current measurements (act) according to:

$$PFL = ( 1 - \frac{Δ {T}_{12 \_ act}}{Δ {T}_{12 \_ cal}} ) * 100 \% \qquad ( 10 )$$

ΔT_{12_act} . . . currently measured temperature difference
ΔT_{12_cal} . . . temperature difference measured during the calibration (without deposit)

Using (9) (R_{1A_12} is invariable), (10) yields:

$$PFL = ( 1 - \frac{{\dot{Q}}_{1 \_ act}}{{\dot{Q}}_{1 \_ cal}} ) * 100 \% \qquad ( 11 )$$

and using (5)

$$PFL = ( 1 - \frac{{R}_{th 2 \_ act} * ( {R}_{th 1 \_ cal} + {R}_{th 2 \_ cal} )}{{R}_{th 2 \_ cal} * ( {R}_{th 1 \_ act} + {R}_{th 2 \_ act} )} ) * 100 \% \qquad ( 12 )$$

Assuming that the thermal resistance in the primary heat path is less than in the secondary heat path and the increase in resistance as a result of deposits is less than the resistance of the primary heat path

$${R}_{th 2 \_ cal} > {R}_{th 1 \_ cal} > {R}_{1 F} , {R}_{2 F} \qquad ( 13 )$$

it holds approximately true that:

$${R}_{th 2 \_ act} ≅ {R}_{th 2 \_ cal} \qquad ( 14 )$$

Thus, (12) yields:

$$PFL = ( 1 - \frac{( {R}_{th 1 \_ cal} + {R}_{th {2}_{cal}} )}{( {R}_{th {1}_{act}} + {R}_{th {2}_{act}} )} ) * 100 \% = ( \frac{{R}_{th 1 \_ act} - {R}_{th 1 \_ cal}}{{R}_{th {1}_{act}} + {R}_{th {2}_{act}}} ) * 100 \% \qquad ( 15 )$$

As it holds true that:

$${R}_{1 A} , {R}_{2 A} , {R}_{1 B} , {R}_{2 B} = const \qquad ( 16 )$$

and given the assumption:

$${R}_{1 C \_ act} ≅ {R}_{1 {C}_{cal}} ≅ const \qquad ( 17 )$$

$${R}_{2 C \_ act} ≅ {R}_{2 C \_ cal} ≅ const$$

it follows, using (7), (8) and (15), that:

$$PFL = ( \frac{{R}_{1 F \_ act}}{{R}_{th {1}_{act}} + {R}_{th {2}_{act}}} ) * 100 \% \qquad ( 18 )$$

and using (13)

$$PFL ≅ K * {R}_{1 F \_ act} * 100 \% \qquad ( 19 )$$

K . . . sensor constant

The measure PFL (the perfomance loss) is thus proportional to the thermal resistance of the deposits in the primary heat path:

$$PFL ∼ {R}_{1 {F}_{act}} \qquad ( 20 )$$

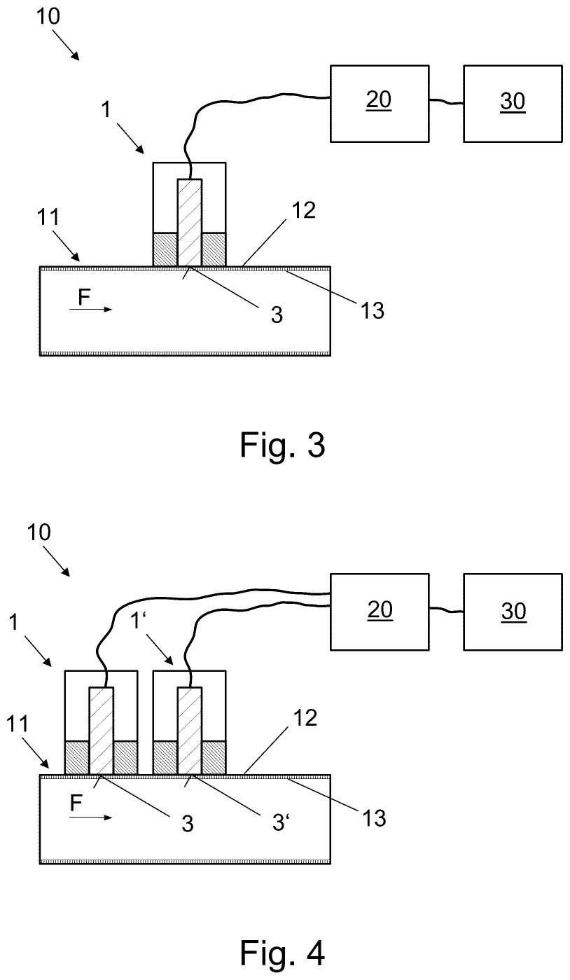

FIG. 3 shows an exemplary embodiment of a detection arrangement 10 for detecting deposits from a flowing medium on an interior wall 12 of a process vessel or a process line 11. The detection arrangement 10 encompasses a detection device 1, which may be configured ac-cording to the exemplary embodiment shown in FIGS. 1 and 2. There is provision in the interior wall 12 of the line 11 for a recess into which the detection section 25 of the detection device 1 projects, with the result that the sensor surface 3 and the reference surface 21 are provided as part of the interior wall 12 of the process line 11. The line 11 is used to convey a cooling or process medium in a direction of conveyance F. This results in deposits 13 forming on the interior wall 12 and deposits 13 forming on the sensor surface 3, the latter deposits being able to be correlated with the deposits 13 on the interior wall 12, which are able to be detected using the detection device 1.

The heat source 7 of the detection device 1 is operated with a constant heating power so as to thus produce a temperature gradient between the first temperature sensor 4 and the second temperature sensor 5. To monitor the deposits 13, the first temperature sensor 4 of the detection device 1 is used to measure a first temperature, and the second temperature sensor 5 of the detection device 1 is used to measure a second temperature. The evaluation unit 20 connected to the detection device 1 calculates the measure PFL described above. This measure PFL is proportional to the thickness of the deposits on the interior wall 12. The evaluation unit 20 calculates this thickness and can relay said thickness to a superordinate system, for example a process control installation, via an interface 30.

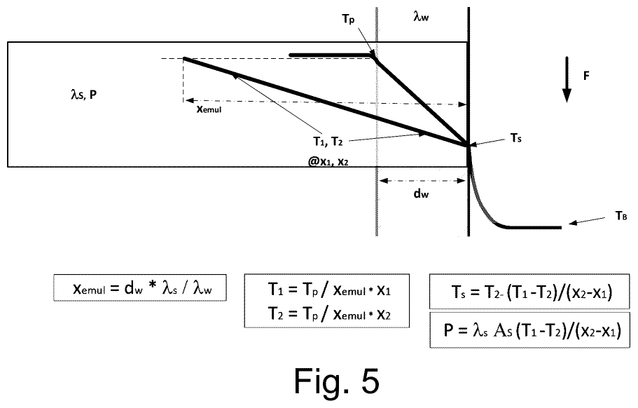

In accordance with a variation of the exemplary embodiment shown in FIG. 3, the detection device 1 is arranged in a supply or discharge line 11, filled with a liquid cooling medium, of a heat exchanger, the heat exchanger permitting an exchange of heat through a heat exchanger wall between a process medium and the cooling medium, wherein a heating power of the heat source or a cooling power of the cold source is adjusted according to a process temperature of the process medium. In this way, deposits on a wall of the heat exchanger that are caused by the liquid cooling medium can be identified without this requiring the detection device to be arranged inside the heat exchanger. In this respect, an emulation of the events on the wall of the heat exchanger by means of the detection device is involved. The emulation is graphically summarized in FIG. 5 and is based on the process temperature T_{P}, the thermal conductivity www of the heat exchanger wall and the wall thickness d_{w} of the heat exchanger wall being known. These parameters of the heat exchanger and of the process are taken as a basis for ascertaining a virtual distance xₑₘᵤₗ at which the process temperature needs to be from the sensor surface 3 in the main body 2 of the detection device 1 in order to set substantially the same temperature at the sensor surface 3 as at the surface of the heat exchanger wall that is in contact with the flowing cooling medium. The virtual distance xₑₘᵤₗ is calculated as follows:

$${x}_{emul} = {d}_{w} \cdot {λ}_{s} / {λ}_{w}$$

The heating power P of the heat source 7 is adjusted according to the temperatures T₁, T₂ determined using the first and second temperature sensors 4, 5 in such a way that the process temperature T_{P} is reached at the virtual distance xₑₘᵤₗ from the sensor surface 3. The heating power P of the heat source 7 is obtained as

$$P = {λ}_{s} {A}_{s} ( {T}_{1} - {T}_{2} ) / ( {x}_{2} - {x}_{1} )$$

where
   λs: thermal conductivity of the main body of the detection device
   Aₛ: cross-sectional area of the main body of the detection device
   T₁: first temperature
   T₂: second temperature
   x₁: first distance (location of the first temperature sensor)
   x₂: second distance (location of the second temperature sensor)

The following setpoint values are predetermined for the first temperature T₁ and the second temperature T₂ according to the virtual distance xₑₘᵤₗ, the distances x₁, x₂ of the temperature sensors from the sensor surface and the predetermined process temperature T_{P}:

$${T}_{1} = {T}_{P} / {x}_{emul} \cdot {x}_{1}$$

$${T}_{2} = {T}_{P} / {x}_{emul} \cdot {x}_{2}$$

The depiction in FIG. 4 shows a further exemplary embodiment of a detection arrangement 10 for detecting deposits from a process medium on an interior wall 12 of a vessel or a line 11, which exemplary embodiment essentially corresponds to that shown in FIG. 3. In contrast to the detection device according to FIG. 3, this exemplary embodiment has provision for multiple, here precisely two, detection devices 1, 1′, which are arranged on the line 11 in such a way that the respective sensor surface 3, 3′ of the detection device 1, 1′ is provided as part of the interior wall 12 of the line 11. The two detection devices 1, 1′ allow different deposits and/or soiling to be distinguished from one another and if necessary combatted using different measures. If for example the first surface temperature of the first sensor surface 3 is set in the range between 35° C. and 40° C., in particular to 37° C., then organic deposits and/or soiling increasingly accumulate on the first sensor surface 3. If the second surface temperature of the second sensor surface 3′ is set in the range between 45° C. and 55° C., in particular to 50° C., then inorganic deposits and/or soiling increasingly accumulate on the second sensor surface 3′. A comparison of the temperature differences recorded by the two detection devices 1, 1′, for example in the evaluation unit 20, can indicate the composition of the deposits 13 formed in the line 11. These findings can be taken as a basis for determining a composition of additives that are routed to the line 11 to break down the deposits 13.

By way of example, a first temperature difference can be determined using the first detection device 1 and a first additive can be introduced into the line 11 according to the determined first temperature difference, and a second temperature difference can be determined using the second detection device 1′ and a second additive can be introduced into the line 11 according to the determined second temperature difference.

The detection devices 1, 1′ described hereinabove can be used to perform a method for detecting deposits and/or soiling on a sensor surface 3 inside a vessel or a line 11 containing a flowing medium 40 using a first detection device 1 that encompasses:
a thermally conductive main body 2 that comprises or is in direct contact with the sensor surface 3,
a heat or cold source 7, arranged on the main body 2, that produces a primary flow of heat Q₁ between the heat or cold source 7 and the sensor surface 3 and a secondary flow of heat Q₂ between the heat or cold source 7 and a reference surface 21,
a detection section that comprises the sensor surface 3 and the reference surface 21 and is arranged inside the vessel or inside the line in contact with the flowing medium 40,
a thermally conductive enveloping body 19 that envelops a part of the main body 2 arranged outside the detection section and comprises the reference surface 21,
an exterior insulation 22 that insulates the enveloping body 19 with respect to its exterior surroundings, and
a first temperature sensor 4, which is arranged on the main body 2 at a first distance from the sensor surface 3, and a second temperature sensor 5, which is arranged on the main body 2 at a second distance from the sensor surface 3, the second distance being greater than the first distance,
   wherein the temperature sensors 4,5 of the first detection device 1 are used to ascertain a temperature difference, and the temperature difference is taken as a basis for detecting deposits and/or soiling on a sensor surface.

### LIST OF REFERENCE SIGNS

1 detection device
2 main body
3 sensor surface
4 temperature sensor
5 temperature sensor
6 temperature sensor
7 heat source
8 insulation means
9 insulation means
10 detection arrangement
11 line
12 wall
13 deposit
18 through-hole
19 enveloping body
20 evaluation unit
21 reference surface
22 exterior insulation
25 detection section (interior section)
26 exterior section
30 interface
40 flowing medium (liquid)
F direction of conveyance
Q₁ primary flow of heat
Q₂ secondary flow of heat

1. A detection device for detecting deposits and/or soiling on a sensor surface inside a vessel or a line containing a flowing medium, wherein the detection device comprises:
a detection section that comprises the sensor surface and is configured to be arranged inside the vessel or inside the line in contact with the flowing medium;
a thermally conductive main body that comprises or is in direct contact with the sensor surface;
a heat or cold source, arranged on thermally conductive main body, for producing a primary flow of heat between the heat or cold source and the sensor surface and a secondary flow of heat between the heat or cold source and a reference surface;
a first temperature sensor arranged on the thermally conductive main body at a first distance from the sensor surface, and a second temperature sensor arranged on the thermally conductive main body at a second distance from the sensor surface, the second distance being greater than the first distance, the first temperature sensor and the second temperature sensor being able to be used to ascertain a temperature difference;
a thermally conductive enveloping body that envelops a part of the main body arranged outside the detection section and comprises the reference surface;
wherein the reference surface is part of the detection section, and the detection device comprises an exterior insulation that insulates the thermally conductive enveloping body with respect to its exterior surroundings.

2. The detection device as claimed in claim 1, wherein the exterior insulation insulates the enveloping body with respect to its exterior surroundings in such a way that the secondary flow of heat is greater than a parasitic flow of heat between the heat or cold source and the surroundings through the enveloping body and through the exterior insulation.

3. The detection device as claimed in claim 1, wherein the enveloping body is produced from a metal or from titanium.

4. The detection device as claimed in claim 1, wherein the detection section is a detection surface.

5. The detection device as claimed in claim 1, wherein the heat or cold source is in the form of an adjustable heat source or cold source.

6. The detection device as claimed in claim 1, wherein the main body is bar-shaped with a round cross section.

7. The detection device as claimed in claim 1, wherein the main body is isotropic and homogeneous in respect of its thermal conductivity.

8. The detection device as claimed in claim 1, wherein the detection device comprises a third temperature sensor arranged on the main body at a third distance from the sensor surface, the third distance being greater than the second distance.

9. The detection device as claimed in claim 8, wherein the heat source is arranged at a fourth distance from the sensor surface, the fourth distance being greater than the second distance and optionally greater than the third distance.

10. The detection device as claimed in claim 1, wherein the detection device encompasses an insulation means that surrounds the main body and that is arranged between an exterior contour of the main body and an interior contour of the enveloping body.

11. The detection device as claimed in claim 10, wherein the insulation means surrounding the main body has an identical thermal resistance on all sides of the main body; or the insulation means comprises a fill or a porous material.

12. (canceled)

13. A detection arrangement for detecting deposits and/or soiling from a flowing medium on a wall of a vessel or a line having thea detection device as claimed in claim 1, wherein the detection section comprising the sensor surface and the reference surface is provided as part of the wall.

14. (canceled)

15. A method for detecting deposits and/or soiling on a sensor surface inside a vessel or a line containing a flowing medium using a first detection device that comprises:
a thermally conductive main body that comprises or is in direct contact with the sensor surface,
a heat or cold source, arranged on the main body, that produces a primary flow of heat between the heat or cold source and the sensor surface and a secondary flow of heat between the heat or cold source and a reference surface,
a detection section that comprises the sensor surface and the reference surface and is arranged inside the vessel or inside the line in contact with the flowing medium,
a thermally conductive enveloping body that envelops a part of the main body arranged outside the detection section and comprises the reference surface,
an exterior insulation that insulates the enveloping body with respect to its exterior surroundings, and
a first temperature sensor, which is arranged on the main body at a first distance from the sensor surface, and a second temperature sensor, which is arranged on the main body at a second distance from the sensor surface, the second distance being greater than the first distance,
wherein the temperature sensors of the first detection device are used to ascertain a temperature difference, and the temperature difference is taken as a basis for detecting deposits and/or soiling on a sensor surface.

16. The method as claimed in claim 15, wherein the heat source is operated with a constant heating power or the cold source is operated with a constant cooling power; or a heating power of the heat source or a cooling power of the cold source is adjusted according to a temperature of the flowing medium.

17. (canceled)

18. The method as claimed in claim 15, wherein the first detection device is arranged in a supply or discharge line, filled with a flowing cooling medium, of a heat exchanger, the heat exchanger permitting an exchange of heat through a heat exchanger wall between a process medium and the cooling medium, wherein a heating power of the heat source or a cooling power of the cold source is adjusted ac-cording to a process temperature of the process medium.

19. The method as claimed in claim 18, wherein the process temperature and a thermal conductivity of the heat exchanger wall and a wall thickness of the heat exchanger wall are taken as a basis for ascertaining a virtual distance at which the process temperature needs to be from the sensor surface in the main body of the first detection device in order to set substantially the same temperature at the sensor surface as at the surface of the heat exchanger wall that is in contact with the cooling medium.

20. The method as claimed in claim 19, wherein the heating power of the heat source or the cooling power of the cold source is additionally adjusted ac-cording to the temperatures determined using the first and second temperature sensors in such a way that the process temperature is reached at the virtual distance from the sensor surface.

21. The method as claimed in claim 15, wherein a third temperature sensor is used to measure a third temperature, the third temperature sensor being arranged on the main body at a third distance from the sensor surface, the third distance being greater than the second distance, wherein a difference between the first and second temperatures is compared with a difference between the second and third temperatures, or wherein a temperature difference between the first and second temperatures is determined and the determined temperature difference is taken as a basis for introducing an additive into the process vessel or into the process line.

22. (canceled)

23. The method as claimed in claim 16, wherein there is provision for a second detection device, which encompasses a bar-shaped, second main body that comprises a second sensor surface provided as part of the wall,
wherein a further first temperature sensor, which is arranged on the second main body at a further first distance from the second sensor surface, is used to measure a further first temperature,
wherein a further second temperature sensor, which is arranged on the second main body at a further second distance from the second sensor surface, the further second distance being greater than the further first distance, is used to measure a further second temperature, and
wherein a second heat source or second cold source arranged on the second main body is used to produce a temperature gradient between the further first temperature sensor and the further second temperature sensor, the first heat source or the first cold source being operated in such a way that a first surface temperature in a range between 35° C. and 40° C., is set at the first sensor surface and the second heat source or the second cold source being operated in such a way that a second surface temperature in a range between 45° C. and 55° C., which is different than the first surface temperature, is set at the second sensor surface.

24. The method as claimed in claim 23, wherein a response of a temperature of the flowing medium is predetermined, the response encompassing a current first process temperature and a future, second process temperature, the first surface temperature being the first process temperature and the second surface temperature being the second process temperature.
